(19) United States
(12) Patent Application Publication
(10) Pub. No.: US 2011/0183567 A1
(43) Pub. Date: Jul. 28, 2011

(54) High strength Non-Woven Elastic Fabrics

(75) Inventors: Ravi R. Vedula, North Ridgeville, OH (US); James E. Bryson, JR., Cuyahoga Falls, OH (US); Mouh-Wahng Lee, Solon, OH (US)

(73) Assignee: LUBRIZOL ADVANCED MATERIALS, INC., Cleveland, OH (US)

(21) Appl. No.: 13/011,954

(22) Filed: Jan. 24, 2011

Related U.S. Application Data
(60) Provisional application No. 61/297,951, filed on Jan. 25, 2010.

(51) Int. Cl. D04H 5/06; B29C 47/00

(52) U.S. Cl. 442/328; 264/211.12

(57) ABSTRACT

Elastic non-woven fabrics are disclosed which are made in a melt blown process or a spunbond process. The fabric is made from a thermoplastic polyurethane polymer mixed with a crosslinking agent to give high strength elastic non-woven fabric. The crosslinking agent is added to the polymer melt prior to the melt passing through the die which forms the individual fibers. Further processing the non-woven is also disclosed.

### CROSS REFERENCE TO RELATED APPLICATION

This application claims priority from Provisional Application Ser. No. 61/297,951 filed on Jan. 25, 2010.

### FIELD OF THE INVENTION

The present invention relates to high strength non-woven elastic fabrics made from lightly crosslinked thermoplastic polyurethane. The crosslinking agent reduces the melt viscosity of the polyurethane allowing smaller diameter fibers to be formed by a melt blown or spunbond process. The non-woven fabric can be further melt processed to form a membrane having porosity. The invention also relates to membranes made from the crosslinked thermoplastic polyurethane from woven fabric as well as membranes made from uncrosslinked thermoplastic polyurethane non-woven fabric.

### BACKGROUND OF THE INVENTION

It is known that thermoplastic polyurethane polymers (TPU) can be processed into non-woven fabrics. The non-woven fabric is made by processes known as melt blown or spunbond. These processes involve melting the polymer in an extruder and passing the polymer melt through a die having several holes. A strand of fiber is formed from each hole in the die. High velocity air is applied adjacent to the fibers, which elongate the fibers and cause them to deposit in a random alignment on a belt below the die.

TPU polymers have many advantages properties, such as being elastic, ability to transmit moisture, good physical properties, breathability, and high abrasion resistance.

Non-woven fabrics can have many uses. The field of uses can be expanded if the non-woven can be made from small fiber sizes. The higher viscosity of the melt for a TPU polymer has heretofore been a hindrance to making small fibers in a non-woven process. If the temperature of the melt is increased, the melt becomes less viscous but physical properties suffer, as the polymer tends to depolymerize at higher temperatures. Additives, such as plasticizers, reduce the viscosity, but are also detrimental to physical properties and also present problems in some applications.

Reduced viscosity of the polymer melt is also desirable because it allows for higher polymer throughput and greater attenuation.

It would be desirable to have an additive which would reduce the TPU polymer melt viscosity, thus allowing fibers to be spun faster and at smaller size while optionally enhancing the physical properties of the fibers in the non-woven fabric.

### SUMMARY OF THE INVENTION

It is an object of the present invention to provide a non-woven fabric made from TPU which has high tensile strength and is elastic.

An exemplary non-woven fabric is made by adding a crosslinking agent to the TPU polymer melt. The crosslinking agent is used at a level of from 5 to 20 weight percent based on the total weight of the TPU polymer and the crosslinking agent.

The crosslinking agent reduces the melt viscosity of the TPU polymer melt allowing the fibers to exit the die at smaller diameters and allowing for greater attenuation.

In an exemplary embodiment, the non-woven is produced by either a melt blown or spunbond process.

In another exemplary embodiment, the non-woven fabric is further melt processed to compact the fabric, such that the air passages in the fabric are reduced. The air passages can be reduced to an extent where a membrane is formed.

In a further exemplary embodiment, the non-woven fabric is calendered into a solid film.

In another exemplary embodiment, an uncrosslinked TPU non-woven fabric is further melt processed to create a membrane.

### BRIEF DESCRIPTION OF THE DRAWING

FIG. 1 shows a graph of die head pressure (psi) as the Y axis vs. weight percent of crosslinking agent as the X axis.

### DETAILED DESCRIPTION OF THE INVENTION

The non-woven fabric of this invention is made from a thermoplastic polyurethane polymer (TPU).

The TPU polymer type used in this invention can be any conventional TPU polymer that is known to the art and in the literature as long as the TPU polymer has adequate molecular weight. The TPU polymer is generally prepared by reacting a polyisocyanate with an intermediate such as a hydroxyl terminated polyester, a hydroxyl terminated polyether, a hydroxyl terminated polycarbonate or mixtures thereof, with one or more chain extenders, all of which are well known to those skilled in the art.

The hydroxyl terminated polyester intermediate is generally a linear polyester having a number average molecular weight (Mn) of from about 500 to about 10,000, desirably from about 700 to about 5,000, and preferably from about 700 to about 4,000, an acid number generally less than 1.3 and preferably less than 0.8. The molecular weight is determined by assay of the terminal functional groups and is related to the number average molecular weight. The polymers are produced by (1) an esterification reaction of one or more glycols with one or more dicarboxylic acids or anhydrides or (2) by transesterification reaction, i.e., the reaction of one or more glycols with esters of dicarboxylic acids. Mole ratios generally in excess of more than one mole of glycol to acid are preferred so as to obtain linear chains having a preponderance of terminal hydroxyl groups. Suitable polyester intermediates also include various lactones such as polycaprolactone typically made from ε-caprolactone and a bifunctional initiator such as diethylene glycol. The dicarboxylic acids of the desired polyester can be aliphatic, cycloaliphatic, aromatic, or combinations thereof. Suitable dicarboxylic acids which may be used alone or in mixtures generally have a total of from 4 to 15 carbon atoms and include: succinic, glutaric, adipic, pimelic, suberic, azelaic, sebacic, dodecanedioic, isophthalic, terephthalic, cyclohexane dicarboxylic, and the like. Anhydrides of the above dicarboxylic acids such as phthalic anhydride, tetrahydrophthalic anhydride, or the like, can also be used. Adipic acid is the preferred acid. The glycols which are reacted to form a desirable polyester intermediate can be aliphatic, aromatic, or combinations thereof, and have a total of from 2 to 12 carbon atoms, and include ethylene glycol, 1,2-propanediol, 1,3-propanediol, 1,3-butanediol, 1,4-butanediol, 1,5-pentanediol, 1,6-hexanediol, 2,2-dimethyl-1,3-propanediol, 1,4-cyclohexanedimethanol, decamethylene glycol, dodecamethylene glycol, and the like, 1,4-butanediol is the preferred glycol.

Hydroxyl terminated polyether intermediates are polyether polyols derived from a diol or polyol having a total of from 2 to 15 carbon atoms, preferably an alkyl diol or glycol which is reacted with an ether comprising an alkylene oxide having from 2 to 6 carbon atoms, typically ethylene oxide or propylene oxide or mixtures thereof. For example, hydroxyl functional polyether can be produced by first reacting propylene glycol with propylene oxide followed by subsequent reaction with ethylene oxide. Primary hydroxyl groups resulting from ethylene oxide are more reactive than secondary hydroxyl groups and thus are preferred. Useful commercial polyether polyols include poly(ethylene glycol) comprising ethylene oxide reacted with ethylene glycol, polypropylene glycol) comprising propylene oxide reacted with propylene glycol, poly(tetramethyl glycol) comprising water reacted with tetrahydrofuran (PTMEG). Polytetramethylene ether glycol (PTMEG) is the preferred polyether intermediate. Polyether polyols further include polyamide adducts of an alkylene oxide and can include, for example, ethylenediamine adduct comprising the reaction product of ethylenediamine and propylene oxide, diethylenetriamine adduct comprising the reaction product of diethylenetriamine with propylene oxide, and similar polyamide type polyether polyols. Copolyethers can also be utilized in the current invention. Typical copolyethers include the reaction product of THF and ethylene oxide or THF and propylene oxide. These are available from BASF as Poly THF B, a block copolymer, and poly THF R, a random copolymer. The various polyether intermediates generally have a number average molecular weight (Mn) as determined by assay of the terminal functional groups which is an average molecular weight greater than about 700, such as from about 700 to about 10,000, desirably from about 1000 to about 5000, and preferably from about 1000 to about 2500. A particular desirable polyether intermediate is a blend of two or more different molecular weight polyethers, such as a blend of 2000 Mₙ and 1000 Mₙ PTMEG.

The most preferred embodiment of this invention uses a polyester intermediate made from the reaction of adipic acid with a 50/50 by weight blend of 1,4-butanediol and 1,6-hexanediol. The blend may also be a 50/50 molar blend of the diols.

The polycarbonate-based polyurethane resin of this invention is prepared by reacting a diisocyanate with a blend of a hydroxyl terminated polycarbonate and a chain extender. The hydroxyl terminated polycarbonate can be prepared by reacting a glycol with a carbonate.

U.S. Pat. No. 4,131,731 is hereby incorporated by reference for its disclosure of hydroxyl terminated polycarbonates and their preparation. Such polycarbonates are linear and have terminal hydroxyl groups with essential exclusion of other terminal groups. The essential reactants are glycols and carbonates. Suitable glycols are selected from cycloaliphatic and aliphatic diols containing 4 to 40, and preferably 4 to 12 carbon atoms, and from polyoxyalkylene glycols containing 2 to 20 alkoxy groups per molecular with each alkoxy group containing 2 to 4 carbon atoms. Diols suitable for use in the present invention include aliphatic diols containing 4 to 12 carbon atoms such as butanediol-1,4, pentanediol-1,4, neopentyl glycol, hexanediol-1,6, 2,2,4-trimethylhexanediol-1,6, decanediol-1,10, hydrogenated dilinoleylglycol, hydrogenated dioleylglycol; and cycloaliphatic diols such as cyclohexanediol-1,3, dimethylolcyclohexane-1,4, cyclohexanediol-1,4, dimethylolcyclohexane-1,3,1,4-endomethylene-2-hydroxy-5-hydroxymethyl cyclohexane, and polyalkylene glycols. The diols used in the reaction may be a single diol or a mixture of diols depending on the properties desired in the finished product.

Polycarbonate intermediates which are hydroxyl terminated are generally those known to the art and in the literature. Suitable carbonates are selected from alkylene carbonates composed of a 5 to 7 membered ring having the following general formula:

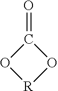

where R is a saturated divalent radical containing 2 to 6 linear carbon atoms. Suitable carbonates for use herein include ethylene carbonate, trimethylene carbonate, tetramethylene carbonate, 1,2-propylene carbonate, 1,2-butylene carbonate, 2,3-butylene carbonate, 1,2-ethylene carbonate, 1,3-pentylene carbonate, 1,4-pentylene carbonate, 2,3-pentylene carbonate, and 2,4-pentylene carbonate.

Also, suitable herein are dialkylcarbonates, cycloaliphatic carbonates, and diarylcarbonates. The dialkylcarbonates can contain 2 to 5 carbon atoms in each alkyl group and specific examples thereof are diethylcarbonate and dipropylcarbonate. Cycloaliphatic carbonates, especially dicycloaliphatic carbonates, can contain 4 to 7 carbon atoms in each cyclic structure, and there can be one or two of such structures. When one group is cycloaliphatic, the other can be either alkyl or aryl. On the other hand, if one group is aryl, the other can be alkyl or cycloaliphatic. Preferred examples of diarylcarbonates, which can contain 6 to 20 carbon atoms in each aryl group, are diphenylcarbonate, ditolylcarbonate, and dinaphthylcarbonate.

The reaction is carried out by reacting a glycol with a carbonate, preferably an alkylene carbonate in the molar range of 10:1 to 1:10, but preferably 3:1 to 1:3 at a temperature of 100° C. to 300° C. and at a pressure in the range of 0.1 to 300 mm of mercury in the presence or absence of an ester interchange catalyst, while removing low boiling glycols by distillation.

More specifically, the hydroxyl terminated polycarbonates are prepared in two stages. In the first stage, a glycol is reacted with an alkylene carbonate to form a low molecular weight hydroxyl terminated polycarbonate. The lower boiling point glycol is removed by distillation at 100° C. to 300° C., preferably at 150° C. to 250° C., under a reduced pressure of 10 to 30 mm Hg, preferably 50 to 200 mm Hg. A fractionating column is used to separate the by-product glycol from the reaction mixture. The by-product glycol is taken off the top of the column and the unreacted alkylene carbonate and glycol reactant are returned to the reaction vessel as reflux. A current of inert gas or an inert solvent can be used to facilitate removal of by-product glycol as it is formed. When amount of by-product glycol obtained indicates that degree of polymerization of the hydroxyl terminated polycarbonate is in the range of 2 to 10, the pressure is gradually reduced to 0.1 to 10 mm Hg and the unreacted glycol and alkylene carbonate are removed. This marks the beginning of the second stage of reaction during which the low molecular weight hydroxyl terminated polycarbonate is condensed by distilling off glycol as it is formed at 100° C. to 300° C., preferably 150° C. to 250° C. and at a pressure of 0.1 to 10 mm Hg until the desired molecular weight of the hydroxyl terminated polycarbonate is attained. Molecular weight (Mn) of the hydroxyl terminated polycarbonates can vary from about 500 to about 10,000 but in a preferred embodiment, it will be in the range of 500 to 2500.

The second necessary ingredient to make the TPU polymer of this invention is a polyisocyanate.

The polyisocyanates of the present invention generally have the formula R(NCO)ₙ where n is generally from 2 to 4 with 2 being highly preferred inasmuch as the composition is a thermoplastic. Thus, polyisocyanates having a functionality of 3 or 4 are utilized in very small amounts, for example less than 5% and desirably less than 2% by weight based upon the total weight of all polyisocyanates, inasmuch as they cause crosslinking R can be aromatic, cycloaliphatic, and aliphatic, or combinations thereof generally having a total of from 2 to about 20 carbon atoms. Examples of suitable aromatic diisocyanates include diphenyl methane-4,4′-diisocyanate (MDI), H₁₂ MDI, m-xylylene diisocyanate (XDI), m-tetramethyl xylylene diisocyanate (TMXDI), phenylene-1,4-diisocyanate (PPDI), 1,5-naphthalene diisocyanate (NDI), and diphenylmethane-3,3′-dimethoxy-4,4′-diisocyanate (TODI). Examples of suitable aliphatic diisocyanates include isophorone diisocyanate (IPDI), 1,4-cyclohexyl diisocyanate (CHDI), hexamethylene diisocyanate (HDI), 1,6-diisocyanato-2,2,4,4-tetramethyl hexane (TMDI), 1,10-decane diisocyanate, and trans-dicyclohexylmethane diisocyanate (HMDI). A highly preferred diisocyanate is MDI containing less than about 3% by weight of ortho-para (2,4) isomer.

The third necessary ingredient to make the TPU polymer of this invention is the chain extender. Suitable chain extenders are lower aliphatic or short chain glycols having from about 2 to about 10 carbon atoms and include for instance ethylene glycol, diethylene glycol, propylene glycol, dipropylene glycol, tripropylene glycol, triethylene glycol, cis-trans-isomers of cyclohexyl dimethylol, neopentyl glycol, 1,4-butanediol, 1,6-hexandiol, 1,3-butanediol, and 1,5-pentanediol. Aromatic glycols can also be used as the chain extender and are the preferred choice for high heat applications. Benzene glycol (HQEE) and xylylene glycols are suitable chain extenders for use in making the TPU of this invention. Xylylene glycol is a mixture of 1,4-di(hydroxymethyl)benzene and 1,2-di(hydroxymethyl)benzene. Benzene glycol is the preferred aromatic chain extender and specifically includes hydroquinone, bis(beta-hydroxyethyl)ether also known as 1,4-di(2-hydroxyethoxy)benzene; resorcinol, i.e., bis(beta-hydroxyethyl)ether also known as 1,3-di(2-hydroxyethyl)benzene; catechol, bis(beta-hydroxyethyl)ether also known as 1,2-di(2-hydroxyethoxy)benzene; and combinations thereof. The preferred chain extender is 1,4-butanediol.

The above three necessary ingredients (hydroxyl terminated intermediate, polyisocyanate, and chain extender) are preferably reacted in the presence of a catalyst.

Generally, any conventional catalyst can be utilized to react the diisocyanate with the hydroxyl terminated intermediate or the chain extender and the same is well known to the art and to the literature. Examples of suitable catalysts include the various alkyl ethers or alkyl thiol ethers of bismuth or tin wherein the alkyl portion has from 1 to about 20 carbon atoms with specific examples including bismuth octoate, bismuth laurate, and the like. Preferred catalysts include the various tin catalysts such as stannous octoate, dibutyltin dioctoate, dibutyltin dilaurate, and the like. The amount of such catalyst is generally small such as from about 20 to about 200 parts per million based upon the total weight of the polyurethane forming monomers.

The TPU polymers of this invention can be made by any of the conventional polymerization methods well known in the art and literature.

Thermoplastic polyurethanes of the present invention are preferably made via a “one shot” process wherein all the components are added together simultaneously or substantially simultaneously to a heated extruder and reacted to form the polyurethane. The equivalent ratio of the diisocyanate to the total equivalents of the hydroxyl terminated intermediate and the diol chain extender is generally from about 0.95 to about 1.10, desirably from about 0.97 to about 1.03, and preferably from about 0.97 to about 1.00. The Shore A hardness of the TPU formed will typically be from 65 A to 95 A, and preferably from about 75 A to about 85 A, to achieve the most desirable properties of the finished article. Reaction temperatures utilizing urethane catalyst are generally from about 175° C. to about 245° C. and preferably from about 180° C. to about 220° C. The molecular weight (Mw) of the thermoplastic polyurethane is generally from about 100,000 to about 800,000 Daltons and desirably from about 150,000 to about 400,000 and preferably about 150,000 to about 350,000 as measured by GPC relative to polystyrene standards.

The thermoplastic polyurethanes can also be prepared utilizing a pre-polymer process. In the pre-polymer route, the hydroxyl terminated intermediate is reacted with generally an equivalent excess of one or more polyisocyanates to form a pre-polymer solution having free or unreacted polyisocyanate therein. Reaction is generally carried out at temperatures of from about 80° C. to about 220° C. and preferably from about 150° C. to about 200° C. in the presence of a suitable urethane catalyst. Subsequently, a selective type of chain extender as noted above is added in an equivalent amount generally equal to the isocyanate end groups as well as to any free or unreacted diisocyanate compounds. The overall equivalent ratio of the total diisocyanate to the total equivalent of the hydroxyl terminated intermediate and the chain extender is thus from about 0.95 to about 1.10, desirably from about 0.98 to about 1.05 and preferably from about 0.99 to about 1.03. The equivalent ratio of the hydroxyl terminated intermediate to the chain extender is adjusted to give the desired hardness, such as from 65 A to 95 A, preferably 75 A to 85 A Shore hardness. The chain extension reaction temperature is generally from about 180° C. to about 250° C. with from about 200° C. to about 240° C. being preferred. Typically, the pre-polymer route can be carried out in any conventional device with an extruder being preferred. Thus, the hydroxyl terminated intermediate is reacted with an equivalent excess of a diisocyanate in a first portion of the extruder to form a pre-polymer solution and subsequently the chain extender is added at a downstream portion and reacted with the pre-polymer solution. Any conventional extruder can be utilized, with the preferred extruders equipped with barrier screws having a length to diameter ratio of at least 20 and preferably at least 25.

Useful additives can be utilized in suitable amounts and include opacifying pigments, colorants, mineral fillers, stabilizers, lubricants, UV absorbers, processing aids, and other additives as desired. Useful opacifying pigments include titanium dioxide, zinc oxide, and titanate yellow, while useful tinting pigments include carbon black, yellow oxides, brown oxides, raw and burnt sienna or umber, chromium oxide green, cadmium pigments, chromium pigments, and other mixed metal oxide and organic pigments. Useful fillers include diatomaceous earth (superfloss) clay, silica, talc, mica, wallostonite, barium sulfate, and calcium carbonate. If desired, useful stabilizers such as antioxidants can be used and include phenolic antioxidants, while useful photostabilizers include organic phosphates, and organotin thiolates (mercaptides). Useful lubricants include metal stearates, paraffin oils and amide waxes. Useful UV absorbers include 2-(2′-hydroxyphenol) benzotriazoles and 2-hydroxybenzophenones. Typical TPU flame retardants can also be added.

Plasticizer additives can also be utilized advantageously to reduce hardness without affecting properties, if they are used in small amounts. Preferably, no plasticizers are used.

During the melt blown or spunbond process to make the non-woven fabric, the TPU polymer described above is lightly crosslinked with a crosslinking agent. The crosslinking agent is a pre-polymer of a hydroxyl terminated intermediate that is a polyether, polyester, polycarbonate, polycaprolactone, or mixture thereof reacted with a polyisocyanate. A polyester or polyether are the preferred hydroxyl terminated intermediates to make the crosslinking agent, with a polyether being the most preferred when used in combination with a polyester TPU. The crosslinking agent, pre-polymer, will have an isocyanate functionality of greater than about 1.0, preferably from about 1.0 to about 3.0, and more preferably from about 1.8 to about 2.2. It is particularly preferred if both ends of hydroxyl terminated intermediate are capped with an isocyanate, thus having an isocyanate functionality of 2.0.

The polyisocyanate used to make the crosslinking agent are the same as described above in making the TPU polymer. A diisocyanate, such as MDI, is the preferred diisocyanate.

The crosslinking agents have a number average molecular weight (Mn) of from about 750 to about 10,000 Daltons, preferably from about 1,200 to about 4,000 and more preferably from about 1,500 to about 2,800. Crosslinking agents at or above about 1500 Mₙ give better set properties.

The weight percent of crosslinking agent used with the TPU polymer is from about 2.0% to about 20%, preferably about 8.0% to about 15%, and more preferably from about 10% to about 13%. The percentage of crosslinking agent used is weight percent based upon the total weight of TPU polymer and crosslinking agent.

The preferred process to make TPU non-woven fabric of this invention involves feeding a preformed TPU polymer to an extruder, to melt the TPU polymer and the crosslinking agent is added continuously downstream near the point where the TPU melt exits the extruder or after the TPU melt exits the extruder. The crosslinking agent can be added to the extruder before the melt exits the extruder or after the melt exits the extruder. If added after the melt exits the extruder, the crosslinking agent needs to be mixed with the TPU melt using static or dynamic mixers to assure proper mixing of the crosslinking agent into the TPU polymer melt. After exiting the extruder, the melted TPU polymer with crosslinking agent flows into a manifold. The manifold feeds a die having multiple holes or openings. The individual fibers exit through the holes. A supply of hot, high speed air is blown along side the fibers to stretch the hot fibers and to deposit them in a random manner on a belt to form a non-woven mat. The formed non-woven mat is carried away by the belt and is wound on a roll.

An important aspect of the non-woven fiber making process is the mixing of the TPU polymer melt with the crosslinking agent. Proper uniform mixing is important to achieve uniform fiber properties. The mixing of the TPU melt and crosslinking agent should be a method which achieves plug-flow, i.e., first in first out. The proper mixing can be achieved with a dynamic mixer or a static mixer. Static mixers are more difficult to clean; therefore, a dynamic mixer is preferred. A dynamic mixer which has a feed screw and mixing pins is the preferred mixer. U.S. Pat. No. 6,709,147, which is incorporated herein by reference, describes such a mixer and has mixing pins which can rotate. The mixing pins can also be in a fixed position, such as attached to the barrel of the mixer and extending toward the centerline of the feed screw. The mixing feed screw can be attached by threads to the end of the extruder screw and the housing of the mixer can be bolted to the extruder machine. The feed screw of the dynamic mixer should be a design which moves the polymer melt in a progressive manner with very little back mixing to achieve plug-flow of the melt. The L/D of the mixing screw should be from over 3 to less than 30, preferably from about 7 to about 20, and more preferably from about 10 to about 12.

The temperature in the mixing zone where the TPU polymer melt is mixed with the crosslinking agent is from about 200° C. to about 240° C., preferably from about 210° C. to about 225° C. These temperatures are necessary to get the reaction while not degrading the polymer.

The formed TPU is reacted with the crosslinking agent during the extrusion process to give a molecular weight (Mw) of the TPU in final fiber form, of from about 200,000 to about 800,000, preferably from about 250,000 to about 500,000, more preferably from about 300,000 to about 450,000.

The processing temperature (the temperature of the polymer melt as it enters the die) should be higher than the melting point of the polymer, and preferably from about 10° C. to about 20° C. above the melting point of the polymer. The higher the melt temperature one can use, the better the extrusion through the die openings. However, if the melt temperature is too high, the polymer can degrade. Therefore, from about 10° C. to about 20° C. above the melting point of the TPU polymer is the optimum for achieving a balance of good extrusion without degradation of the polymer. If the melt temperature is too low, polymer can solidify in the die openings and cause fiber defects.

The two processes to make the non-woven fabric of this invention are the spunbond process and the melt blown process. The basic concepts of both processes are well understood by those skilled in the art of making non-wovens. The spunbond process usually directs room temperature air beside the die creating a suction which pulls the fibers from the die and stretches the fibers before depositing the fibers in a random orientation on a belt. For the spunbond process, the distance from the die to the collector (belt) can vary from about 1 to 2 meters. The spunbond process is best used for making non-woven fabric where the individual fibers have a diameter of 10 micrometers or larger, preferably 15 micrometers or larger. The melt blown process usually uses pressurized heated air, for example, 400 to 450° C., to push the fibers through the die and stretch the fibers before they are deposited on the collector in a random orientation. For the melt blown process, the distance from the die to the collector is less than for the spunbond process and is usually from 0.05 to 0.75 meters. The melt blown process can be used to make smaller size fibers than the spunbond process. The fiber diameter for melt blown produced fibers can be less than 1 micrometer and as small as 0.2 micrometer diameter. Both processes can, of course, make larger diameter fibers than mentioned above. Both processes use a die with several holes, usually about 30 to 100 holes per inch of die width. The amount of holes per inch will usually depend on the diameter of the holes, which in turn determine the size of the individual fibers. The thickness of the non-woven fabric will vary greatly, depending on the size of the fibers being produced and the take off speed of the belt carrying the non-woven. Typical thickness for a melt blown non-woven is from about 0.5 mil to 10 mils (0.0127 mm to 0.254 mm). For non-woven fabric made with the spunbond process, the typical thickness is from about 5 mils to 30 mils (0.127 mm to 0.762 mm). The thickness can vary from those described above depending on end use applications.

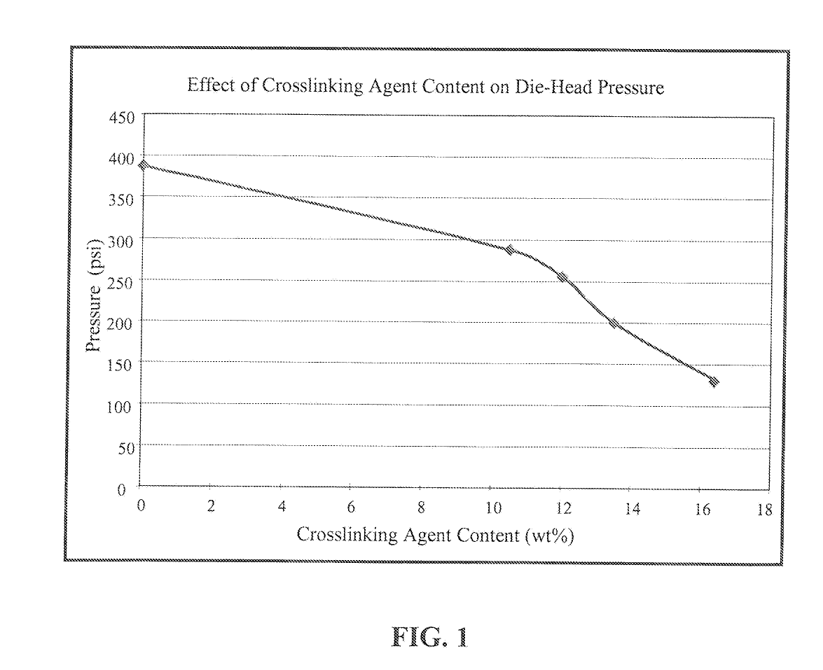

The crosslinking agent mentioned above accomplishes several objectives. It improves the tensile strength and set properties of the fibers in the non-woven fabric. The crosslinking agent also causes bonding to occur between the fibers by reacting across the surface of fibers that touch when in the form of the non-woven mat. That is, the fibers are chemically bonded where they touch another TPU fiber in the non-woven fabric. This feature adds durability to the non-woven fabric making it easier to handle without separating. The crosslinking agent also initially reduces the melt viscosity of the TPU melt, resulting in less head pressure on the die during extrusion of the fibers. This reduced die head pressure allows the melt to flow through the die at a faster speed and allows smaller diameter fibers to be made. For example, a crosslinking agent level of about 12-14 weight percent can reduce the die head pressure by about 50%. In FIG. 1, there is a graph of die head pressure vs. weight percent of crosslinking agent.

The non-woven fabric of this invention can be further processed, such as by calendering. The heated calendar rolls can compress the non-woven to reduce the thickness and to reduce the size of the air passages in the fabric. The compressed non-woven can be used as membranes for various applications, such as filtration. The non-woven can be calendered where all the air space is eliminated and a solid film is formed.

This invention allows fibers making up the non-woven to be made very small, such as less than 1 micrometer. This small size fibers allows the non-woven to be compressed such that the air passages are very small, making the non-woven acceptable for a range of end uses, such as filtration or in breathable garments. The smaller the fiber diameter, the smaller the pore size is able to be achieved.

Another embodiment of the present invention involves membranes made from the crosslinked TPU non-woven fabric or from TPU non-woven fabric without crosslinking agent. The non-woven fabric is compressed to reduce it thickness, such as by processing through heated calender rolls. The step of compressing the non-woven fabric also reduces the pore size of the non-woven. The pore size in the membrane is important to determine the desired air flow through the membrane as well as the amount of water vapor transmitted through the membrane. Since a water droplet is about 100 micrometers in size, the pore size should be less than 100 micrometers if the end use application requires the membrane to be water resistant. If water is under some pressure, such as falling rain, then the pore size needs to be smaller, such as 25 micrometers or less, to be waterproof. The membranes of this invention have a pore size of from 100 nanometers to less than 100 micrometers, depending on the desired end use application. Another factor which will determine the desired pore size is the desired air flow through the membrane. Air flow is influenced by the number of pores, pore size, and the mean flow path through the pores. Air flow of 25 ft.³/min./ft² (7.621 m³/min./m²) or greater is considered very open. For outerwear garments, air flow of about 5 to 10 ft³/min./ft² (1.524 to 3.048 m³/min./m²) is considered desirable. The membranes of this invention can have from 2 to 500 ft³/min./ft² (0.601 to 152.4 m³/min./m²) air flow, depending on the desired end use application. Air flow is measured according to ASTM D737-96 test method.

The thickness of the membrane can vary depending on the thickness of the non-woven fabric as well as the number of layers of non-woven fabric in the membrane. The amount the non-woven is compressed in the calendering operation will also determine the thickness of the membrane. The membrane can be made from a single layer of non-woven fabric or multiple layers of non-woven fabric. For example, a 5 mils (0.0127 cm) thick non-woven fabric made by the melt blown process would make a desirable membrane having a thickness of about 1.5 mils (0.00381 cm). Another example would be a 10 mil (0.0254 cm) thick non-woven fabric made by the spunbond process would make a desirable membrane having a thickness of about 6.5 mils (0.01651 cm). The thickness of the membrane can vary depending on the thickness of the non-woven fabric and the number of layers of non-woven fabric used to make the membrane.

For applications where it is desired to adhere the membrane to other materials, it is preferred to use a TPU which does not have the crosslinking agent. This could be the case in garments, where the TPU membrane needs to adhere to other fabrics.

The test procedure employed to measure the tensile strength and other elastic properties is one which was developed by DuPont for elastic yarns, but it has been modified to test non-woven fabric. The test subjects fabric to a series of 5 cycles. In each cycle, the fabric is stretched to 300% elongation, and relaxed using a constant extension rate (between the original gauge length and 300% elongation). The % set is measured after the 5^{th} cycle. Then, the fabric specimen is taken through a 6^{th} cycle and stretched to breaking. The instrument records the load at each extension, the highest load before breaking, and the breaking load in units of grams-force as well as the breaking elongation and maximum elongation. The test is normally conducted at room temperature (23° C.±2° C.; and 50%±5% humidity).

The non-woven fabrics described herein may be used for filtration, in the construction of apparel, as industrial fabrics, and other similar uses. The opportunities to use such non-woven fabrics are increased, and the performance of such fabrics in many it not all of these applications is improved if the fibers that make up the fabric are stronger and/or finer. The present invention provides for fiber that are both stronger and finer, compared to more conventional fibers, and so the non-woven fabrics made from the fibers are useful in a wider range of applications and deliver improved performance, derived from the increased strength and/or smaller diameter of the fibers used in the construction of the fabric. For example, filtration media that includes the non-woven fabric of the invention can have improved effectiveness, increasing throughput, allowing for finer filtration, reducing the size, thickness or amount of filter media required, or any combination thereof.

The invention will be better understood by reference to the following examples.

### EXAMPLES

The TPU polymer used in the Examples was made by reacting a polyester hydroxyl terminated intermediate (polyol) with 1,4-butanediol chain extender and MDI. The polyester polyol was made by reacting adipic acid with a 50/50 mixture of 1,4-butanediol and 1,6-hexanediol. The polyol had a Mn of 2500. The TPU was made by the one-shot process. The crosslinking agent added to the TPU during the process to make the non-woven was a polyether pre-polymer made by reacting 1000 Mn PTMEG with MDI to create a polyether end capped with isocyanate. The crosslinking agent was used at levels of 10 wt. % of the combined weight of TPU plus crosslinking agent for Example 1. In Example 2, 10 wt. % of crosslinking agent was used.

### Example 1

This Example is presented to show that the crosslinking agent reduces the die head pressure in a melt blown process. The results are shown in FIG. 1. The wt. % levels of crosslinking agent used were 0, 10, 12.5, and 16.5. As can be seen from FIG. 1, as the level of crosslinking agent is increased, the die head pressure is reduced substantially.

### Example 2

This Example is presented to show the dramatic increase in tensile strength of the elastic fiber non-woven fabric made with crosslinking agent versus without crosslinking agent. The data shows that the strength (max load), of the non-woven increases as much as about 100% when the crosslinking agent is used. The data also shows that the tensile set is reduced by about 50% when using the crosslinking agent while maintaining a high degree of elongation demonstrating a dramatic increase in elasticity with the use of the crosslinking agent.

The test procedure used was that described above for testing elastic properties. An Instron Model 5564 tensiometer with Merlin Software was used. The test conditions were at 23° C.±2° C. and 50%±5% humidity with a cross head speed of 500 mm/min. The test specimens were 50.0 mm in length, 1.27 cm in width and 9.25 mils (0.0235 cm) thick. Both fabrics had a nominal weight of 60 grams/m² (GSM). The weight average molecular weight (Mw) of the crosslinked fibers was 376,088 Daltons, while the Mw of the non-crosslinked fibers was 116,106 Daltons. Four specimens were tested and the results are the mean value of the 4 specimens tested. The results are shown in Table I.

TABLE I

| | | Prior Art | This Invention |
|---|---|---|---|
| | | Without | With |
| | | Crosslinking | Crosslinking |
| | Units | Agent | Agent |
| 1^{st} Load Pull @ 100% | g/force | 135 | 230 |
| 1^{st} Load Pull @ 150% | g/force | 156 | 266 |
| 1^{st} Load Pull @ 200% | g/force | 179 | 307 |
| 1^{st} Load Pull @ 300% | g/force | 250 | 450 |
| 1^{st} Unload Pull @ 200% | g/force | 53 | 115 |
| 1^{st} Unload Pull @ 150% | g/force | 35 | 83 |
| 1^{st} Unload Pull @ 100% | g/force | 24 | 62 |
| % Set After 1^{st} Pull | % | 16.29% | 16.79% |
| 5^{th} Load Pull @ 100% | g/force | 44 | 95 |
| 5^{th} Load Pull @ 150% | g/force | 63 | 128 |
| 5^{th} Load Pull @ 200% | g/force | 81 | 162 |
| 5^{th} Load Pull @ 300% | g/force | 173 | 343 |
| 5^{th} Unload Pull @ 200% | g/force | 47 | 104 |
| 5^{th} Unload Pull @ 150% | g/force | 32 | 77 |
| 5^{th} Unload Pull @ 100% | g/force | 21 | 55 |
| % Set After 5^{th} Pull | % | 37.46% | 26.40% |
| Max Load | g/force | 763 | 1631 |
| Max Elongation | % | 601% | 517% |

All of the above data are a mean value for 4 specimens tested.

From the above data, it can be seen that the non-woven fabric of this invention has much higher tensile strength, while maintaining good elastic properties of elongation and % set.

While in accordance with the Patent statutes, the best mode and preferred embodiment has been set forth, the scope of the invention is not limited thereto, but rather by the scope of the attached claims.

What is claimed is:

1. A non-woven fabric comprising:
(a) thermoplastic polyurethane polymer; and
(b) crosslinking agent.

2. The non-woven fabric of claim 1, wherein said thermoplastic polyurethane polymer is selected from the group consisting of polyester polyurethane, polyether polyurethane, and polycarbonate polyurethane.

3. The non-woven fabric of claim 2, wherein said thermoplastic polyurethane polymer is a polyester polyurethane.

4. The non-woven fabric of claim 1, wherein said crosslinking agent is present at a level of from 5 to 20 weight percent based on the total weight of said thermoplastic polyurethane polymer and said crosslinking agent.

5. The non-woven fabric of claim 4, wherein said crosslinking agent is present at a level of from 8 to 15 weight percent.

6. The non-woven fabric of claim 4, wherein said crosslinking agent is an isocyanate terminated prepolymer selected from the group consisting of polyether prepolymer and polyester prepolymer.

7. The non-woven fabric of claim 4, wherein said crosslinking agent has a number average molecular weight of from 1,000 to 10,000 Daltons.

8. The non-woven fabric of claim 2, wherein said thermoplastic polyurethane polymer is made by reacting:
(a) at least one hydroxyl terminated intermediate;
(b) at least one glycol chain extender; and
(c) at least one polyisocyanate.

9. The non-woven fabric of claim 8, wherein said polyisocyanate is a diisocyanate.

10. The non-woven fabric of claim 9, wherein said thermoplastic polyurethane has a weight average molecular weight of from 100,000 to 800,000 Daltons.

11. A process for producing a non-woven fabric comprising the steps of:
(a) adding a preformed thermoplastic polyurethane polymer to an extruder; and
(b) melting said thermoplastic polymer in said extruder to create a polymer melt; and
(c) adding a crosslinking agent to said polymer melt; and
(d) passing said polymer melt mixed with said crosslinking agent through a die having multiple holes from which fibers are formed in a process selected from the group consisting of melt blown process, and spunbond process; and
(e) collecting said fibers in a random alignment to form said non-woven fabric.

12. The process of claim 11, wherein said process is a spunbond process.

13. The process of claim 12, wherein said process is a melt blown process.

14. The process of claim 11, wherein said crosslinking agent is present at a level of from 5 to 20 weight percent, based on the total weight of said preformed thermoplastic polyurethane polymer and said crosslinking agent.

15. The process of claim 14, wherein said crosslinking agent is present at a level of from 8 to 15 weight percent.

16. The process of claim 11, wherein said preformed thermoplastic polyurethane polymer is made by reacting:
(a) at least one hydroxyl terminated intermediate;
(b) at least one glycol chain extender; and
(c) at least one polyisocyanate.

17. The process of claim 16, wherein said preformed thermoplastic polyurethane has a weight average molecular weight of from 100,000 to 800,000 Daltons; and wherein said polyisocyanate is a diisocyanate; and wherein said crosslinking agent has a number average molecular weight of from 1,000 to 10,000.

18. The process of claim 11, wherein said non-woven fabric is passed through a calender operation to compress said non-woven fabric.

19. An article comprising the non-woven fabric of claim 1, wherein said article is selected from the group consisting of consumer apparel, industrial apparel, medical article, sport article, protective article, and filtration membrane.

20. A porous membrane made from a non-woven thermoplastic polyurethane fabric and having a plurality of pores.

21. The membrane of claim 20 wherein said membrane has a pore size of from 100 nanometers to less than 100 micrometers.

22. The membrane of claim 20 wherein said membrane has an air flow rate through said membrane of from 2 to 500 ft.³/min./ft² (0.601 to 152.4 m³/min./m²) as measured according to ASTM D737-96.

23. The membrane of claim 20 wherein said thermoplastic polyurethane fabric is made using a crosslinking agent.

24. The membrane of claim 22 wherein said membrane has an air flow rate through said membrane of from 5 to 10 ft³/min./ft² (1.524 to 3.048 m³/min./m²).
